(19) United States
(12) Patent Application Publication
(10) Pub. No.: US 2014/0302838 A1
(43) Pub. Date: Oct. 9, 2014

(54) DEVICE AND METHOD FOR CONTROLLING PHONEBOOK SYNCHRONIZATION

(71) Applicant: Pantech Co., Ltd., Seoul (KR)

(72) Inventors: Jo An Na, Seoul (KR); Mo Hyun Kim, Seoul (KR)

(73) Assignee: Pantech Co., Ltd., Seoul (KR)

(21) Appl. No.: 14/245,884

(22) Filed: Apr. 4, 2014

(30) Foreign Application Priority Data
Apr. 5, 2013 (KR) 10-2013-0037601

(51) Int. Cl. H04W 8/18

(52) U.S. Cl. CPC H04W 8/183
USPC 455/418; 455/564

(57) ABSTRACT

A device and method for controlling synchronization in a device including receiving, from an access requesting program, a request for accessing a phonebook object stored in a terminal; determining whether the phonebook object is permitted to interoperate with the access requesting program; and providing information of the phonebook object if the phonebook object is determined to be permitted to interoperate with the access requesting program.

### CROSS-REFERENCE TO RELATED APPLICATION

This application claims priority to and the benefit under 35 U.S.C. §119(a) of Korean Patent Application No. 10-2013-0037601, filed on Apr. 5, 2013, the entire disclosure of which is incorporated by reference for all purposes.

### BACKGROUND

1. Field

The following disclosure relates to a device and method for controlling phonebook synchronization.

2. Discussion of the Background

With the development of Internet technology, a number of social networking service (SNS) users has increased. SNS refers to a service that enables a user to have relationships with others in a virtual space on the Internet or a service that provides a user with communication to share various pieces of information. Also, as the SNS can be used on a device, for example, a mobile device, communications with contacts may be made at anytime and anywhere. An SNS is generally installed on a device in a form of a program, and is widely used.

An SNS service involves a process of associating each user with friends or other people. The process includes, for example, recommending or registering someone as a friend on a corresponding SNS for performing communication between the user and the friend or other people. This association process is performed using various methods, which typically includes a method of synchronizing information of one or more phonebook objects stored in a device of a user with a contact list of a certain program, for example, a friend list of an SNS. The phonebook synchronization method may interoperate or synchronize a contact list of a corresponding SNS with information of one or more phonebook objects meeting the requirements for the corresponding SNS among information of the one or more phonebook objects stored in a device of a user. However, this conventional synchronization method performs overall phonebook synchronization, and as a result, even an unwanted person may be added to a friend list of an SNS or recommended as an SNS friend. Accordingly, there is difficulty in managing a contact list or a friend list of an SNS and an issue of personal information being exposed to an unwanted person.

### SUMMARY

Exemplary embodiments of the present invention provide a device and method for controlling phonebook synchronization.

Additional features of the invention will be set forth in the description which follows, and in part will be apparent from the description, or may be learned by practice of the invention.

Exemplary embodiments of the present invention provide a method for controlling synchronization in a device including receiving, from an access requesting program, a request for accessing a phonebook object stored in the device; determining whether the phonebook object is permitted to interoperate with the access requesting program; and providing information of the phonebook object if the phonebook object is determined to be permitted to interoperate with the access requesting program.

Exemplary embodiments of the present invention provide a method for controlling synchronization in a server including receiving, from a first user, a request for removing contact information of the first user from a contact list of the second user stored in the server; removing contact information of the first user from the contact list of the second user; and transmitting, to an access requesting program of the second user, the request for removing contact information of the first user from a contact list of the access requesting program of the second user, in which the access requesting program of the second user is installed in a device of the second user.

Exemplary embodiments of the present invention provide a device to control synchronization of contact information including a storage to store a phonebook object and to receive, from an access requesting program, a request to access information of the phonebook object; an interoperability filter to set an interoperability permission of the phonebook object with respect to the access requesting program; and an interoperability management unit to determine whether the access requesting program is permitted to interoperate with the phonebook object according to the interoperability permission, to store the interoperability permission of the access requesting program, and to allow providing of information of the phonebook object if the phonebook object is determined to be permitted to interoperate with the access requesting program.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1A is a diagram illustrating a system configuration of a device according to an exemplary embodiment of the present invention.

FIG. 1B is a diagram illustrating an interoperability filter of a device according to an exemplary embodiment of the present invention.

FIG. 1C is a diagram illustrating a phonebook database of a device according to an exemplary embodiment of the present invention.

FIG. 2 is a flowchart illustrating a method for controlling phonebook synchronization in a device according to an exemplary embodiment of the present invention.

FIG. 3 is a flowchart illustrating a detailed view of selective synchronization operation 240 of FIG. 2 according to an exemplary embodiment of the present invention.

FIG. 4A is a diagram illustrating a user interface for setting an interoperability permission for a phonebook object according to an exemplary embodiment of the present invention.

FIG. 4B is a diagram illustrating a user interface for setting interoperability permissions for a phonebook object and corresponding access requesting programs according to an exemplary embodiment of the present invention.

FIG. 4C is a diagram illustrating a user interface for setting interoperability permissions for access requesting programs corresponding to a phonebook object according to an exemplary embodiment of the present invention.

FIG. 5 is an operational flowchart illustrating a method for controlling phonebook synchronization in a device according to an exemplary embodiment of the present invention.

FIG. 6 is an operational flowchart illustrating a method for controlling phonebook synchronization in a server according to an exemplary embodiment of the present invention.

FIG. 7 is an operational flowchart illustrating a method for controlling phonebook synchronization in a program according to an exemplary embodiment of the present invention.

FIG. 8 is a diagram illustrating a program referring to a phonebook interoperability filter, a user interface, and a phonebook database according to an exemplary embodiment of the present invention.

FIG. 9 is a diagram illustrating a configuration of the device of FIG. 1A, FIG. 1B, and FIG. 1C.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

Prior to description, some of the terms used in the present disclosure are as follows. The description of the terms used herein are exemplary, which are for the purpose of more clearly describing particular embodiments, and are not intended to be limiting of the present disclosure.

A program may refer to software for providing a predetermined service or function in a device, such as a mobile device. The program may include, without limitation, an application, an always on top (AOT) application, or a service object. For example, in a device running an Android® operating system (OS), the program may include an application, also known as an App, and may include a service object. Also, a unit or a part that constitutes the program may be referred to as a component. The component may be referred to as a window when the component occupies a display. The component may be named differently based on an OS type. For example, the component may be referred to as an activity in an Android® OS, and as a user interface (UI) view in an iOS®.

A social networking service (SNS) program may refer to a program for providing an SNS in a device. Also, the SNS program may include a program enabling communication with other users, for example, a chatting program, a messenger program, and the like.

A device may include a tool or components able to perform an SNS function. A device may include, for example, a tablet, a tab, a pad, a personal digital assistant (PDA), a smart phone, a mobile phone, a mobile terminal, a laptop computer, a personal computer (PC), and the like. For example, a device, such as a mobile terminal, may include hardware components, such as one or more processors, a memory, a touch screen display, a camera, and the like. Also, the units, modules, elements, devices, applications, and components of the apparatuses, systems, and/or mobile terminals herein described, may include hardware and software, may also include firmware, to perform various operations of the terminal including those described herein, may be combined or remain separate, and may be stored in one or more storage devices or computer-readable media.

An access authority may refer to an authority of a particular user or device to access a program, a process, or a computer system in a computer network. An access authority may permit a user or device to refer to data or a program and to use the data or program in a particular form. Further, an access authority may be understood as an authority to permit a program, an application, and/or a process to refer to and use arbitrary data or program within a terminal.

Access authority may include one or more manipulations including, for example, reading a data item, for example, a file or a record, or a particular section, writing a new item being appended or a current item being modified, deleting an item, and the like.

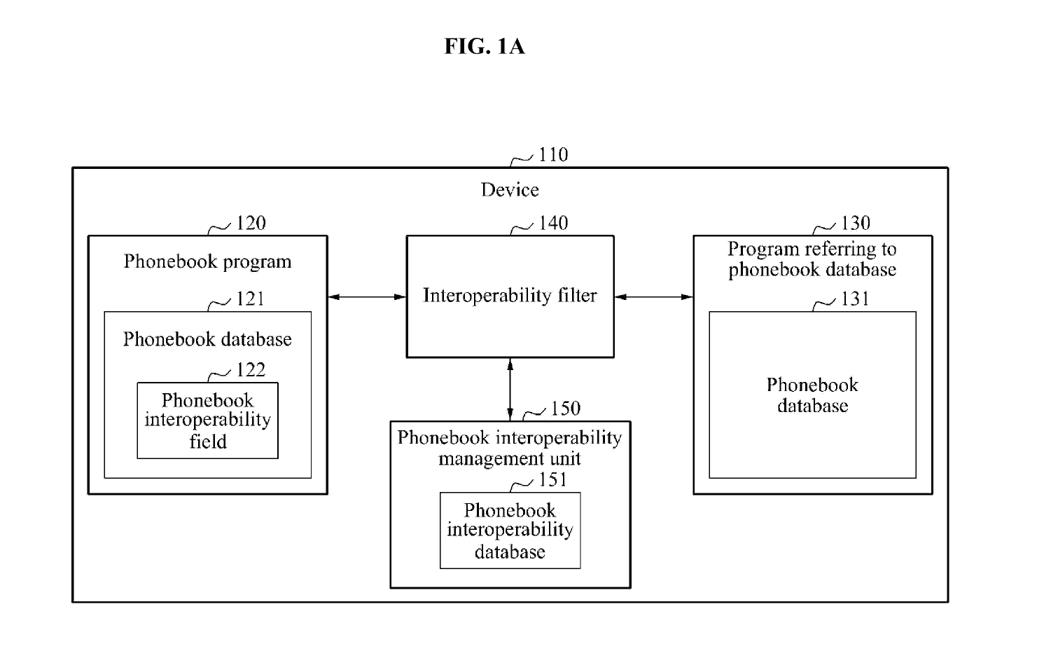

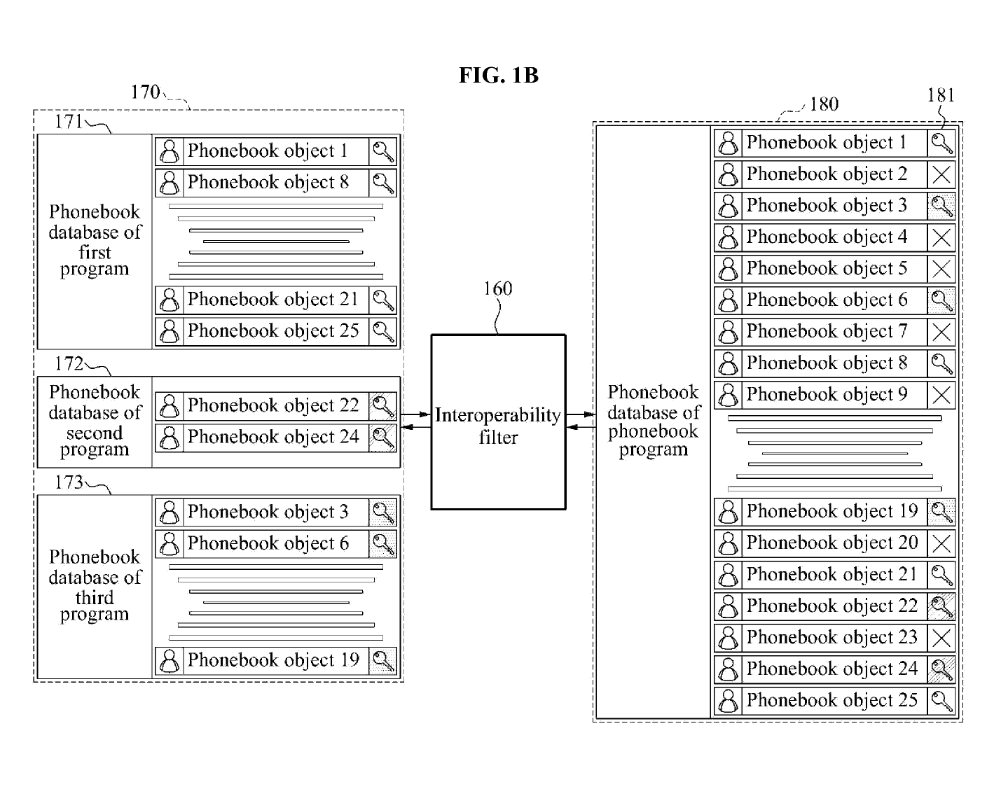

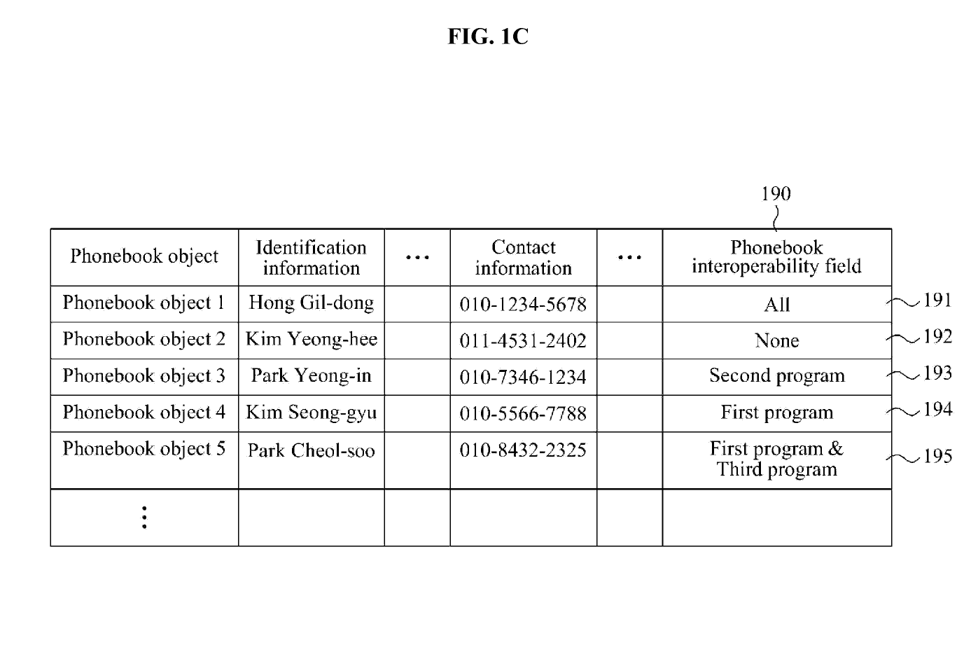

FIG. 1A, FIG. 1B, and FIG. 1C are diagrams illustrating a system configuration of a device according to exemplary embodiments of the present invention. FIG. 1A is a diagram illustrating a system configuration of a device according to an exemplary embodiment of the present invention. FIG. 1B is a diagram illustrating an interoperability filter of a device according to an exemplary embodiment of the present invention. FIG. 1C is a diagram illustrating a phonebook database of a device according to an exemplary embodiment of the present invention.

Referring to FIG. 1A, device 110 includes a phonebook program 120, a program 130, which may refer to a phonebook database or other contact information repository, an interoperability filter 140, and a phonebook interoperability management unit 150.

The phonebook program 120, such as a phone directory program, includes a phonebook database 121. The phonebook database 121 may include information of a phonebook object or entry and a phonebook interoperability field 122. The phonebook object may refer to an entry of information corresponding to a person or entity stored in the phonebook database 121. Also, the information of the phonebook object may include at least one of identification information and contact information. The identification information may include at least one of name information, nickname information, avatar information, and picture information. Also, the contact information may include at least one of mobile phone information, wired phone information, electronic mail information, and address information. Also, the phonebook interoperability field 122 may correspond to a field indicating whether interoperability between the information of the phonebook object and the program 130 is permitted. A further description of the phonebook database 121 and the phonebook interoperability field 122 is provided with reference to FIG. 1C below. According to aspects of the invention, the phonebook object or contact information of users may be stored in a storage of a device or a corresponding server, and is not limited to a phonebook database.

The program 130, which may refer to a phonebook database, may be installed in the device 110. More specifically, the program 130 may refer to the phonebook database 121 of the phonebook program 120 to perform a function of the program 130. The program 130 may include an SNS program, a messenger program, and the like. The program 130, which may refer to at least one phonebook database, may be installed in the device 110. Also, the program 130 may include a phonebook database 131, which may include contact information for a list of contacts with whom the user communicates with via the program 130. More specifically, the phonebook database 131 of the program 130 may include information associated with a contact or person with which a user of the device 110 may communicate using the program 130, for example, a friend on an SNS. Although a phonebook database is described as being associated with or stored within an access requesting program for storing contact information of various users, aspects of the invention are not limited thereto, such that other repository of contact information may be used that may or may not be associated with a phone number.

The interoperability filter 140 may set whether information of a phonebook object included in the phonebook database 121 is permitted or set to interoperate with the program 130. Based on interoperability setting or permission of the information of the phonebook object with the program 130, the information of the phonebook object may be provided to the program 130 or providing of the information of the phonebook object to the program 130 may be prevented or obstructed. The interoperability filter 140 may validate or determine whether the program 130 has phonebook access authority using the phonebook interoperability management unit 150. In an example, the phonebook access authority may refer to an authority to access the phonebook database 122 of the phonebook program 120. Although FIG. 1A illustrates the phonebook interoperability management unit 150 and the interoperability filter 140 separately, aspects of the invention are not limited thereto, such that the interoperability filter 140 may include the phonebook interoperability management unit 150. Further, configuration of other components illustrated in FIG. 1A are not limited thereto, such that different configuration may be provided.

The phonebook interoperability management unit 150 may determine whether the program 130 has phonebook access authority, and may store information associated with the determination in a phonebook interoperability database 151. Also, the phonebook interoperability management unit 150 may allow or disallow the program 130 to access the phonebook program 120 based on whether the program 130 has phonebook access authority. In an example, the user may set the phonebook access authority of the program 130. However, aspects of the invention are not limited thereto, such that the phonebook authority of the program 130 may be automatically set based on one or more reference criteria, for example, by a user, programmer, manufacturer, provider, and the like.

Also, the phonebook interoperability management unit 150 may detect whether a change occurs to a portion of a plurality of programs referring to the phonebook database. More specifically, when a change (e.g., installation, deletion, or update of an SNS program) occurs to a portion of a plurality of programs referring to the phonebook database, the phonebook interoperability management unit 150 may recognize, for one or more programs referring to the phonebook database or access requesting programs, whether a corresponding program includes a phonebook access authority. Further, the phonebook interoperability management unit 150 may store, in the phonebook interoperability database 151, information associated with the access requesting program including the phonebook access authority. The access requesting program, which may refer to the phonebook database, having the phonebook access authority may be included in the phonebook interoperability database 151.

Referring to FIG. 1B, an interoperability filter 160 may provide information of a phonebook object between a phonebook database 180 of a phonebook program and a phonebook database 170 of an access requesting program, or may block the providing of the information of the phonebook object between the phonebook database 180 of the phonebook program and the phonebook database 170 of the access requesting program.

More specifically, the phonebook database 180 may include information of a plurality of phonebook objects and a phonebook interoperability field 181 values corresponding to one or more of the plurality of phonebook objects. Referring to FIG. 1B, phonebook interoperability field values of a phonebook object 1, a phonebook object 8, a phonebook object 21, and a phonebook object 25 may indicate that the respective phonebook objects are set or permitted to interoperate with a first program, which may refer to the phonebook database. Phonebook interoperability field values of a phonebook object 22 and a phonebook object 24 may indicate that the respective phonebook objects are set or permitted to interoperate with a second program, which may refer to the phonebook database. Phonebook interoperability field values of a phonebook object 3, a phonebook object 6, and a phonebook object 19 may indicate that the respective phonebook objects are set or permitted to interoperate with a third program, which may refer to the phonebook database. Also, phonebook interoperability field values of a phonebook object 2, a phonebook object 4, and a phonebook object 5 may indicate that the respective phonebook objects are set not to interoperate with a program, which may refer to the phonebook database.

The interoperability filter 160 may determine whether the information of the phonebook objects 1 through 25 may be authorized or set to interoperate with the first through third programs using the phonebook interoperability field values of the phonebook database 180. Further, the interoperability filter 160 may provide the information of the phonebook object 1, the phonebook object 8, the phonebook object 21, and the phonebook object 25 to the first program, and the first program may store the information of the phonebook object 1, the phonebook object 8, the phonebook object 21, and the phonebook object 25 in the phonebook database 171. The program referring to the phonebook database (e.g., first program, second program, or third program) may map the authorized phonebook object to a contact or entry in its contact list. For example, the first program may map the phonebook object 1 to a first contact in the contact list, the phonebook object 8 to a second contact in the contact list, the phonebook object 21 to a third contact in the contact list, and the phonebook object 25 to a fourth contact in the contact list, and may store the mapping information in the phonebook database 171.

Similarly, the interoperability filter 160 may provide the information of the phonebook object 22 and the phonebook object 24 to the second program, and may provide the information of the phonebook object 3, the phonebook object 6, and the phonebook object 19 to the third program. Further, the interoperability filter 160 may block information of a phonebook object set not to interoperate with a program, which may refer to a phonebook database, such as the phonebook object 2, the phonebook object 4, and the phonebook object 5. More specifically, the interoperability filter 160 may not provide the information of the unauthorized phonebook object to one or more programs, such as the first program, second program, and third program.

Referring to FIG. 1C, a phonebook database 190 of a phonebook program may include a phonebook object field, an identification information field, a contact information field, and a phonebook interoperability field. In an example, at least one value may be provided in the identification information field and the contact information field. Although FIG. 1C shows one phonebook interoperability field corresponding to one phonebook object, aspects of the invention are not limited thereto such that a phonebook interoperability field may correspond to more than one phonebook object.

In the example of FIG. 1C, a field value of a phonebook interoperability field 191 of a phonebook object 1 may be set to ‘All.’ This may indicate that information of the phonebook object 1 is set or permitted to interoperate with all programs referring to a phonebook database or access requesting programs installed in a device. Also, a field value of a phonebook interoperability field 192 of a phonebook object 2 may be set to ‘None.’ This may indicate that information of the phonebook object 2 is set not to interoperate with any program referring to a phonebook database installed in the device. Because a field value of a phonebook interoperability field 193 of a phonebook object 3 is set to a ‘second program,’ information of the phonebook object 3 may be set to interoperate with the second program. Similarly, because a field value of a phonebook interoperability field 194 of a phonebook object 4 is set to a ‘first program,’ information of the phonebook object 4 may be set to interoperate with the first program. Also, because a field value of a phonebook interoperability field 195 of a phonebook object 5 is set to ‘first program & third program,’ information of the phonebook object 5 may be set to interoperate with both the first program and the third program.

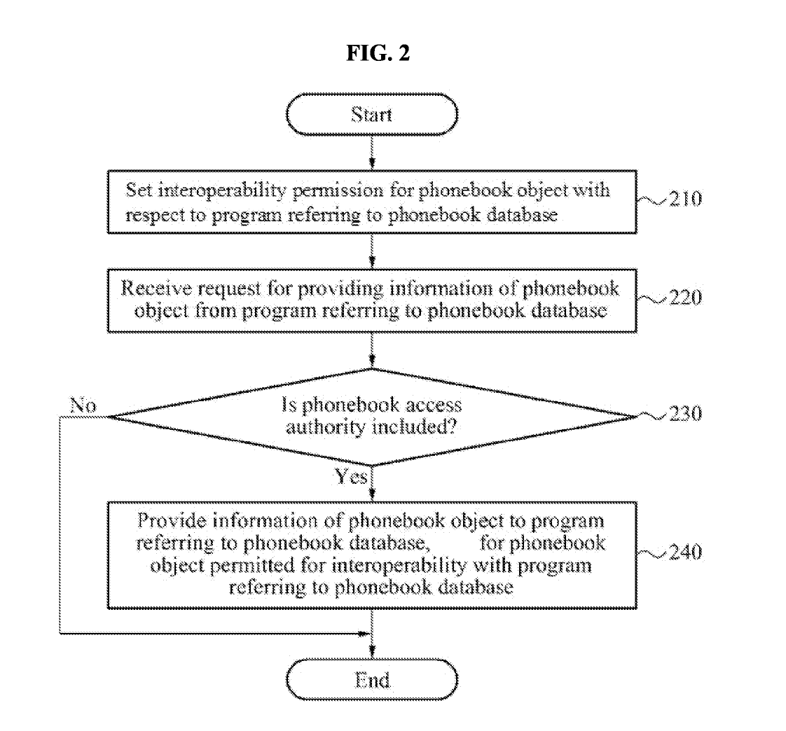

FIG. 2 is a flowchart illustrating a method for controlling phonebook synchronization in a device according to an exemplary embodiment of the present invention.

Referring to FIG. 2, in operation 210, interoperability of a phonebook object with a program, which may refer to a phonebook database, may be set. First, in operation 210, information associated with the phonebook object may be stored in the phonebook database. More specifically, in operation 210, an input of contact information or identification information of the phonebook object may be received from a user or another source. The contact information may include, for example, at least one of mobile phone information, wired phone information, electronic mail information, and address information. The identification information may include, for example, at least one of name information, nickname information, avatar information, and picture information.

Also, in operation 210, an input of a selection as to whether a program, which may refer to the phonebook database, or an access requesting program may be permitted to interoperate with the phonebook object may be received from the user or another source. The selection as to whether the interoperability is permitted may refer to at least one of a selection as to whether the interoperability is permitted for all programs, a selection as to whether the interoperability is denied for all programs, and a selection as to whether the interoperability is permitted for one or more select programs.

Further, in operation 210, a request for the information of the phonebook object may be received from the program referring to the phonebook database. In response to the request, an input of selection as to whether the interoperability is permitted for the respective program may be received from the user. Also, in operation 210, an input of the selection as to whether the interoperability is permitted for a particular program may be received from the user at a predetermined cycle or by a request from the user.

In an example, an interoperability checkbox may be displayed on a user interface of the device for a phonebook program, for example, to receive the input of the selection as to whether the interoperability is permitted. The interoperability checkbox of the user interface may correspond to the phonebook interoperability field of the phonebook database. Accordingly, the phonebook interoperability field may be configured based on the selection as to whether the interoperability checkbox is selected. For example, when the user interface is displayed to receive the input of the selection as to whether the interoperability is permitted for all programs, and the user selects to allow interoperability for all programs, information of interoperability between the phonebook object and all the programs may be stored in the phonebook interoperability field. Further, when the user selects, using the user interface, only a first program among five programs, which may refer to the phonebook database, as a program permitted to interoperate with the phonebook object, interoperability setting or permission between information of the phonebook object and only the first program may be stored in the phonebook interoperability field. More specifically, when the first program is permitted to interoperate with the respective phonebook object, the first program may map the authorized or permitted information of the phonebook object to a contact or entry in a contact list of the first program. Accordingly, in operation 210, a determination of whether the information of the phonebook object is set or permitted to interoperate with a program, which may refer to the phonebook database, may be determined using the phonebook interoperability field stored in the phonebook database.

In operation 220, a request for information of the phonebook object may be received from a program referring to the phonebook database or an access requesting program. The access requesting program may request the information of the phonebook object when performing synchronization. More specifically, when the access requesting program performs synchronization, the access requesting program may request the information of the phonebook object at a predetermined cycle, may request the information of the phonebook object according to a request from the user, and/or may request the information of the phonebook object by requesting through a server, which may manage the access requesting program or program referring to the phonebook database.

In operation 230, a determination of whether the access requesting program has phonebook access authority or permission for accessing the phonebook object included in the phonebook database is made. In an example, a phonebook interoperability database of a phonebook interoperability management unit may store information associated with an access requesting program including a phonebook access authority. Further, a determination may be made as to whether the access requesting program includes the phonebook access authority using the phonebook interoperability database in operation 230. Further, when the access requesting program requesting the information of the phonebook object does not include the phonebook access authority, the request for providing information from the access requesting program without a phonebook access authority may be denied in operation 230.

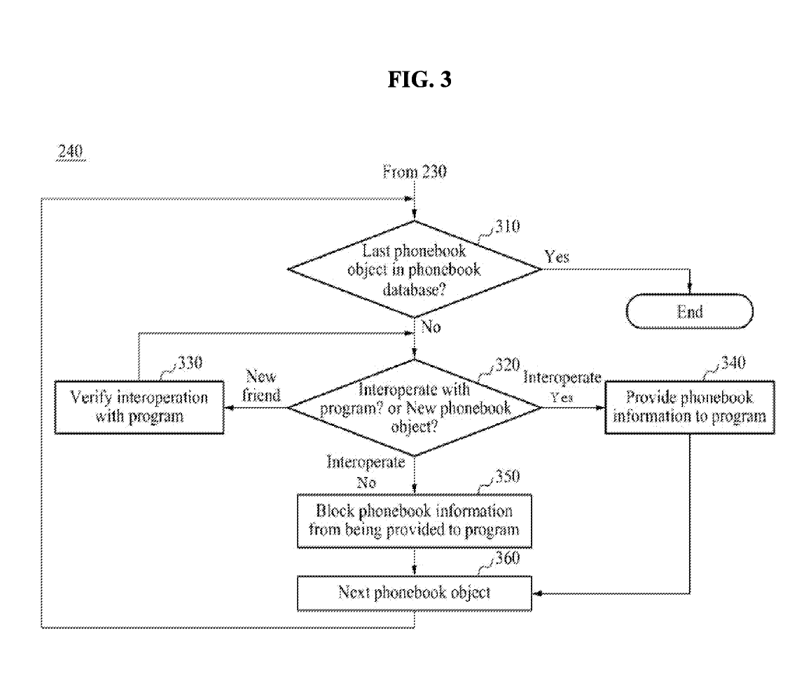

In operation 240, the access requesting program may be provided with information of one or more phonebook objects allowed for the interoperability with the access requesting program among phonebook objects. More specifically, in operation 240, determination may be made as to whether the information of the phonebook object is set or permitted to interoperate with the access requesting program. When the information of the phonebook object is set or permitted to interoperate with the access requesting program, the information of the phonebook object may be provided to the access requesting program in operation 240. When the information of the phonebook object is not set or permitted to interoperate with the access requesting program, the providing of the information of the phonebook object to the access requesting program may be blocked in operation 240. A more detailed description of operation 240 is provided with reference to FIG. 3.

FIG. 3 is a flowchart illustrating a detailed view of selective synchronization operation 240 of FIG. 2 according to an exemplary embodiment of the present invention.

Referring to FIG. 3, in operation 310, determination may be made as to whether a phonebook database search is conducted to a last phonebook object in the phonebook database. More specifically, in operation 310, when the access requesting program requests the information of the phonebook object included in the phonebook database, a search may be conducted from a first phonebook object to a last phonebook object included in the phonebook database.

In operation 320, when a found phonebook object is determined not to be the last phonebook object included in the phonebook database, determination may be made as to whether identification information of the found phonebook object is set or permitted to interoperate with the access requesting program and/or whether the found phonebook object is a new phonebook object.

In operation 330, when the found phonebook object is determined to be a new phonebook object, a determination of whether information of the found phonebook object is set or permitted to interoperate with the access requesting program is made. More specifically, in operation 330, a determination of whether the information of the found phonebook object is set or permitted to interoperate with the access requesting program may be made by referring to the phonebook interoperability field.

Also, in operation 340, when the information of the found phonebook object is determined to be set or permitted to interoperate with the access requesting program, the information of the found phonebook object may be provided to the access requesting program.

More specifically, in operation 340, information of the phonebook object to be provided to the access requesting program may be extracted. Further, in operation 340, identification information, which may include at least one of name information, nickname information, avatar information, and picture information, of the found phonebook object may be extracted. Similarly, contact information, which may include at least one of mobile phone information, wired phone information, electronic mail information, and address information, of the found phonebook object may be extracted in operation 340. According to aspects of the invention, only information requested from the program may be extracted among the information of the found phonebook object. For example, a first program may request, from the phonebook database, mobile phone information of the phonebook object among the available identification information of the phonebook object, and a second program may request, from the phonebook database, electronic mail information of the phonebook object among the available contact information of the phonebook object. Accordingly, only the information requested from the first program and the second program may be extracted in response to the request, and the mobile phone information may be provided to the first program and the electronic mail information may be provided to the second program. However, aspects of the invention are not limited thereto, such that all information included in the information of the found phonebook object may be extracted.

Also, in operation 340, the extracted information of the phonebook object may be provided to the access requesting program. Accordingly, the access requesting program may add the received information of the phonebook object to the phonebook database or storage of the access requesting program using the received information of the phonebook object.

Also, in operation 340, when information set for the user to confirm whether the information of the phonebook object is to be provided to the access requesting program is included, a confirmation of whether the information set by the user is provided to the access requesting program may be made. Further, notification or indication that information is requested from the access requesting program may correspond to information seeking confirmation by the user. Information seeking confirmation may be provided to the user using a pop-up window. Also, in operation 340, the inputted selection as to whether permission of the interoperability with the access requesting program or program referring to the phonebook database may be received from the user using a pop-up window or a user interface. When the user selects not to provide the information of the phonebook object to the access requesting program, the information of the phonebook object may not be provided to the access requesting program in operation 340. When the information of the phonebook object is set to be provided to the access requesting program by the user, a confirmation of whether to provide the information of the phonebook object may be provided to the access requesting program in operation 340.

Also, in operation 350, when the information of the found phonebook object is set not to interoperate with the access requesting program, the providing of the information of the found phonebook object to the access requesting program may be blocked. More specifically, in operation 350, even though a request is made from the access requesting program, the information of the found phonebook object may not be provided to the access requesting program. Also, in operation 350, a request for removing the found phonebook object from a contact list of the access requesting program may be transmitted to the access requesting program. In response to the request, the access requesting program may delete the information of the found phonebook object from its phonebook database or contact list.

Also, in operation 350, a request for removing the found phonebook object from a list of contacts of the access requesting program may be transmitted, from the device of the user or a first device, to a server corresponding to the access requesting program. In response to the request, the server may delete contact information corresponding to the found phonebook object, which may be stored in a database of the server. Also, the server may transmit the request for removing user information to an access requesting program installed on a second device, which may belong to the contact or person corresponding to the found phonebook object. In response to the request, the access requesting program of the second device belonging to the respective contact may delete information associated with the user of the first device requested to be removed. More specifically, the access requesting program of the second device may delete requested information of the user of the first device stored in the phonebook database of the access requesting program of the second device. Also, when a phonebook object is removed from the phonebook database of the first device and the access requesting program performs synchronization, a request for deleting the removed phonebook object from a second device, which may belong to a contact corresponding to the removed phonebook object, may be transmitted to the access requesting program stored in the second device or the server. Further, the information of the removed phonebook object may be set not to interoperate with the access requesting program of the first device

Also, in operation 360, a search for a next phonebook object may be conducted. When the next phonebook object is present, operations 310 through 360 may be performed on the next phonebook object iteratively. However, when the next phonebook object is absent, the phonebook database search may be stopped.

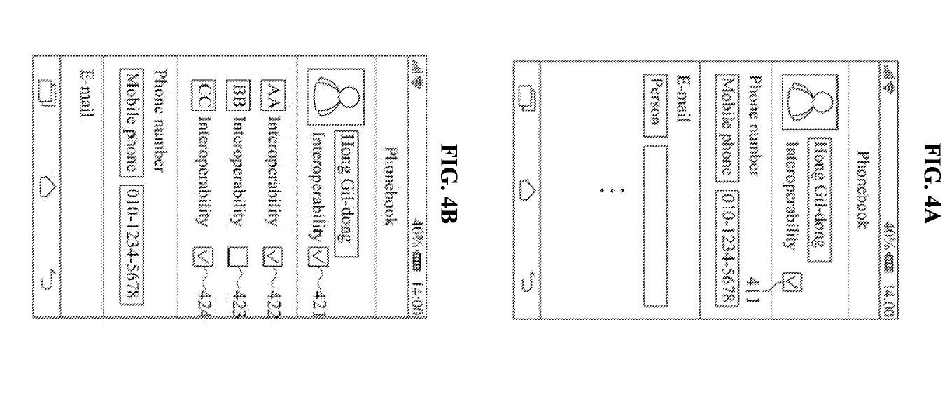

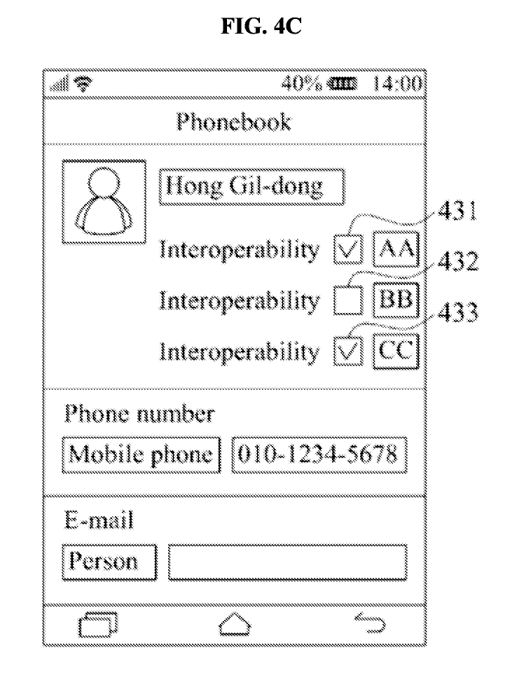

FIG. 4A is a diagram illustrating a user interface for setting an interoperability permission for a phonebook object according to an exemplary embodiment of the present invention. FIG. 4B is a diagram illustrating a user interface for setting interoperability permissions for a phonebook object and corresponding access requesting programs according to an exemplary embodiment of the present invention. FIG. 4C is a diagram illustrating a user interface for setting interoperability permissions for access requesting programs corresponding to a phonebook object according to an exemplary embodiment of the present invention.

Referring to FIG. 4A, a user may input, edit, or delete information of a phonebook object using a display of a phonebook program. More specifically, the user may input and edit is identification information of the phonebook object, which may include at least one of name information, nickname information, picture information, or avatar information of the phonebook object. Identification information may be displayed using the display of the phonebook program shown in FIG. 4A. Also, the user may input and edit contact information of the phonebook object, which may include at least one of mobile phone information, wired phone information, electronic mail information, or address information of the phonebook object. Contact information may be displayed using the display of the phonebook program shown in FIG. 4A.

Also, the display of the phonebook program shown in FIG. 4A includes a user interface including an interoperability checkbox 411 for a phonebook object. The interoperability checkbox 411 may be used for receiving, from the user, an input of a selection as to whether interoperability is permitted for all programs that may refer to a phonebook database. When the user marks the interoperability checkbox 411, for example, by making a selection on the interoperability checkbox 411 using a touch gesture, the device may set a phonebook interoperability field of the phonebook database to interoperate information associated with Hong Gil-dong, a phonebook object or entry, with all the programs that may refer to the phonebook database. However, when the user does not indicate or select interoperability selection on the interoperability checkbox 411, the phonebook program may set the phonebook interoperability field not to interoperate identification information of Hong Gil-dong with any program that may refer to the phonebook database.

Referring to FIG. 4B, a display of a phonebook program includes a user interface including a first interoperability checkbox 421, a second interoperability checkbox 422, a third interoperability checkbox 423, and a fourth interoperability checkbox 424 corresponding to a contact and different access requesting programs. Initially, only the first interoperability checkbox 421 may be displayed on the user interface of FIG. 4B. When the user marks the first interoperability checkbox 421, the user interface of the phonebook program shown in FIG. 4B may additionally display the second interoperability checkbox 422, the third interoperability checkbox 423, and the fourth interoperability checkbox 424. The phonebook program may obtain a list of programs that may refer to the phonebook database or access requesting programs installed in the device, and may display the programs that may refer to the phonebook database on the user interface of the phonebook program shown in FIG. 4B. The second interoperability checkbox 422 may be for receiving, from the user, an input of a selection as to whether interoperability of information associated with Hong Gil-dong with a program AA, which may refer to the phonebook database, is permitted. Similarly, the third interoperability checkbox 423 and the fourth interoperability checkbox 424 may be for receiving, from the user, an input of a selection as to whether interoperability of the information associated with Hong Gil-dong with program BB, and program CC, both of which may refer to the phonebook database, is permitted, respectively. Further, when the user marks the second interoperability checkbox 422 and the fourth interoperability checkbox 424 but not the third interoperability checkbox 423, the phonebook program may set a phonebook interoperability field to interoperate the information associated with Hong Gil-dong with the program AA and the program CC, and may set a phonebook interoperability field not to interoperate the information associated with Hong Gil-dong with the program BB.

Also, a user interface of a phonebook program shown in FIG. 4C may include a user interface feature, for example, a first interoperability checkbox 431, a second interoperability checkbox 432, and a third interoperability checkbox 433. The first interoperability checkbox 431 may be for receiving, from the user, an input of a selection as to whether interoperability of information associated with Hong Gil-dong with a program AA is permitted. Similarly, the second interoperability checkbox 432 and third interoperability checkbox 433 may be for receiving, from the user, an input of a selection as to whether interoperability of the information associated with Hong Gil-dong with a program BB and a program CC is permitted, respectively. Accordingly, the user may select a program, which may refer to a phonebook database, with which the information associated with Hong Gil-dong may interoperate, among the three programs AA, BB, and CC, using the user interface features, such as interoperability check boxes. Although interoperability checkboxes are used as user interface feature to capture interoperability permission setting information, aspects of the invention are not limited thereto, such that other user interface features may be used, for example, sliders, highlighting, bolding, other indicators, pull down or dropdown menus, radio buttons, checkboxes, selection boxes, list boxes, combo boxes, cycle buttons, and the like.

Also, referring to FIG. 4C, the user may input a selection as to whether interoperability is permitted for each piece of information of the phonebook object. More specifically, although not illustrated, a user interface of a phonebook program may include a user interface for receiving an input of a selection as to whether interoperability of contact information and identification information is permitted with a particular program or programs. For example, a first input field on a user interface may be for receiving an input of a selection as to whether interoperability of mobile phone information of contact information is permitted, a second input field may be for receiving an input of a selection as to whether interoperability of electronic mail information of contact information is permitted, and a third input field may be for receiving an input of a selection as to whether interoperability of nickname information of identification information is permitted. Accordingly, the user may select at least one of the mobile phone information, the electronic mail information, and the nickname information to interoperate with one or more programs that may refer to the phonebook database.

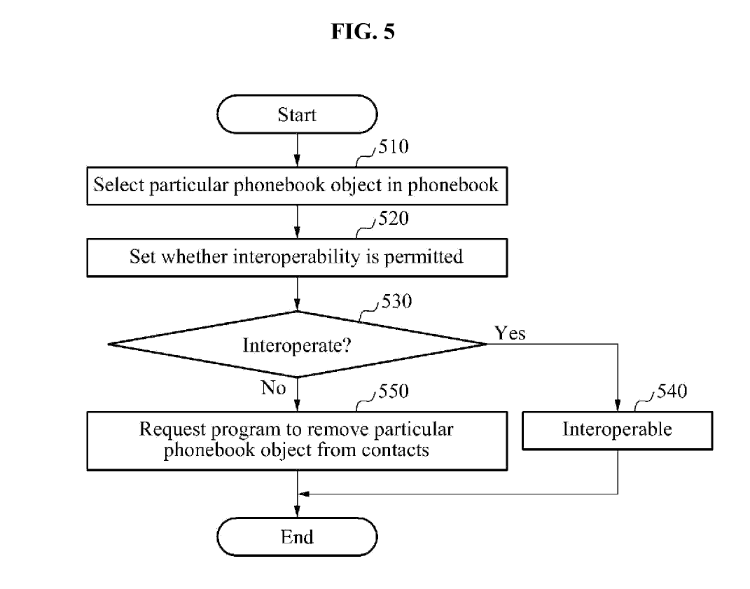

FIG. 5 is an operational flowchart illustrating a method for controlling phonebook synchronization in a device according to an exemplary embodiment of the present invention.

Referring to FIG. 5, in operation 510, a particular phonebook object may be selected in a phonebook database. For example, a user may select a particular phonebook object in a phonebook program via a user interface, and the device may select the particular phonebook object in the phonebook program in response to the selection by the user.

Also, in operation 520, permission for interoperability of information of the particular phonebook object with an access requesting program may be set. The device may receive, from the user, at least one of a selection as to whether interoperability is permitted for some or all access requesting programs or programs that may refer to the phonebook database. Further, the device may receive a selection as to whether interoperability is permitted for an access requesting program, with which information of the particular phonebook object may be set or permitted to interoperate among available access requesting programs. Selections may be made using a user interface and a corresponding phonebook interoperability field.

Also, in operation 530, determination may be made as to whether the information of the particular phonebook object is set or permitted to interoperate with the access requesting program. More specifically, the access requesting program may perform synchronization of a phonebook database or contact list of the access requesting program. By performing synchronization, the access requesting program may request the information of the phonebook object from the phonebook program. Further, determination may be made as to whether the information of the particular phonebook object is set to interoperate with one or more access requesting programs in response to the request. According to aspects of the invention, the phonebook database or contact list of the access requesting program may be managed by a server or stored in the respective device housing the access requesting program. Further, the server may request the information of the phonebook object from the phonebook program of the device.

When the information of the particular phonebook object is set to interoperate with the access requesting program, the phonebook program may provide the information of the particular phonebook object to the access requesting program in operation 540.

Also, when the information of the particular phonebook object is not set or permitted to interoperate with the access requesting program, the access requesting program may be requested to remove the contact corresponding to the phonebook object in operation 550. Accordingly, the access requesting program may delete the information of the particular phonebook object from the phonebook database of the access requesting program. The access requesting program may perform synchronization for a phonebook object of which interoperability is permitted but not for the phonebook object of which interoperability is not set or permitted.

When the server manages the phonebook database of the access requesting program, the server may be requested to remove the information of a particular phonebook object from a list of contacts of the access requesting program installed on another device or a second device, which may belong to a different user. In response to the request, the server may delete information associated with the user of the first device from a phonebook database or contact list of an access requesting program of the second device.

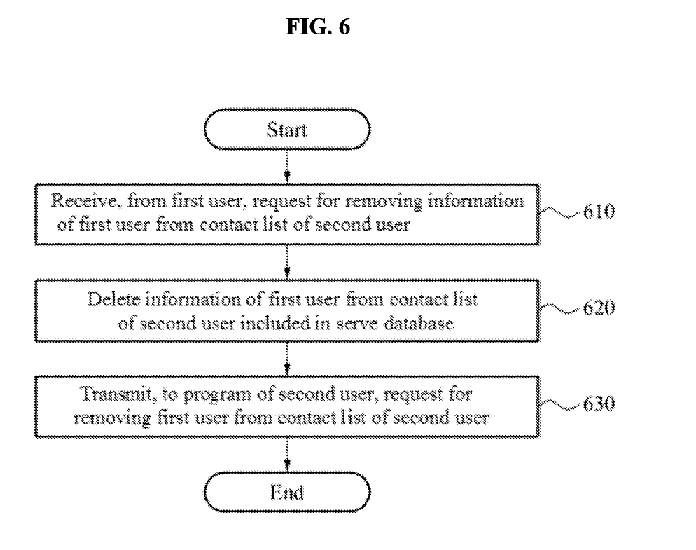

FIG. 6 is an operational flowchart illustrating a method for controlling phonebook synchronization in a server according to an exemplary embodiment of the present invention.

Referring to FIG. 6, in operation 610, when editing a phonebook database in a first device, a request for removing from information of a second user corresponding to a phonebook object, for example, an SNS account of the second user, may be received from a first user of the first device through, for example, an SNS account of the first user. More specifically, the server may exert control over at least a portion of a service provided by an access requesting program, which may refer to the phonebook database. For example, when the first user registers the second user as a contact in the phonebook database of the phonebook program in the first device and an access requesting program in the first device of the first user performs synchronization, the access requesting program of the first user may store information of the second user in a list of contacts stored in a server database for the first user. Also, when the first user removes the second user from its list of contacts and the access requesting program of the first user performs synchronization, the first device of the first user may transmit, to the server, a request for removing information of the first user from a list of contacts of the second user. More specifically, the access requesting program of the first device of the first user may transmit, to the server, the request for removing information of the first user from a list of contacts of the second user. Also, the first device of the first user may transmit, to the server, a request for removing the second user from a list of contacts of the first user.

Also, in operation 620, information associated with the first user may be deleted from contact list of the second user included in the server database. Such deletions may prevent or reduce a likelihood of personal information of the first user from being exposed to the second user. Also, as the server deletes the information associated with the first user from the contact list of the second user included in the server database, the second user may also remove the information associated with the first user from the contact list of the second user. According to aspects of the invention, when the server manages phonebook databases of access requesting programs of all users, in response to the request for removing information of the first user from contact list of the second user, the server may delete information associated with the first user from a phonebook database of an access requesting program of the second user. Accordingly, the server may perform synchronization for a user maintaining interoperability with the second user.

Also, in operation 630, the request for removing the first user from a contact list of the second user may be transmitted to the access requesting program of the second user. More specifically, in response to the request for removing the first user from the contact list of the second user being received from the first user, the server may transmit the request for removing the first user from the contact list of the second user to the access requesting program of the second user.

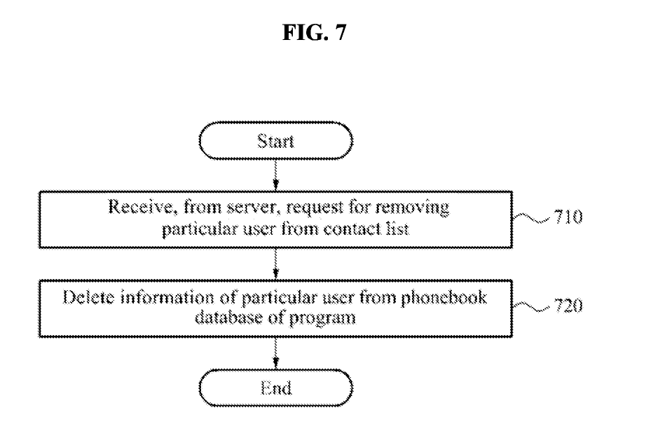

FIG. 7 is an operational flowchart illustrating a method for controlling phonebook synchronization in a program according to an exemplary embodiment of the present invention.

Referring to FIG. 7, in operation 710, a request for removing a particular user, such as a first user, from a contact list of another user, such as a second user, may be received from a server. For example, a program referring to a phonebook database or access requesting program may request synchronization to the server, and may receive, from the server, a request for removing the particular user from contact list of another user during performing synchronization. Also, even if the access requesting program does not perform synchronization, the access requesting program may receive, from the server, a request for removing the particular user from a contact list of another user.

Also, in operation 720, information associated with the particular user may be deleted from a phonebook database of the access requesting program installed on a device of the second user. Accordingly, some or all information associated with the particular user requested to be removed from the contact list of the second user may be deleted from the access requesting program. Further, when the request for removing the particular user from the contact list of the second user is received from the server during synchronization with the server and information associated with the particular user requested to be removed is absent in the phonebook database of the access requesting program of the second user, remaining synchronization operation or operations may continue to be performed.

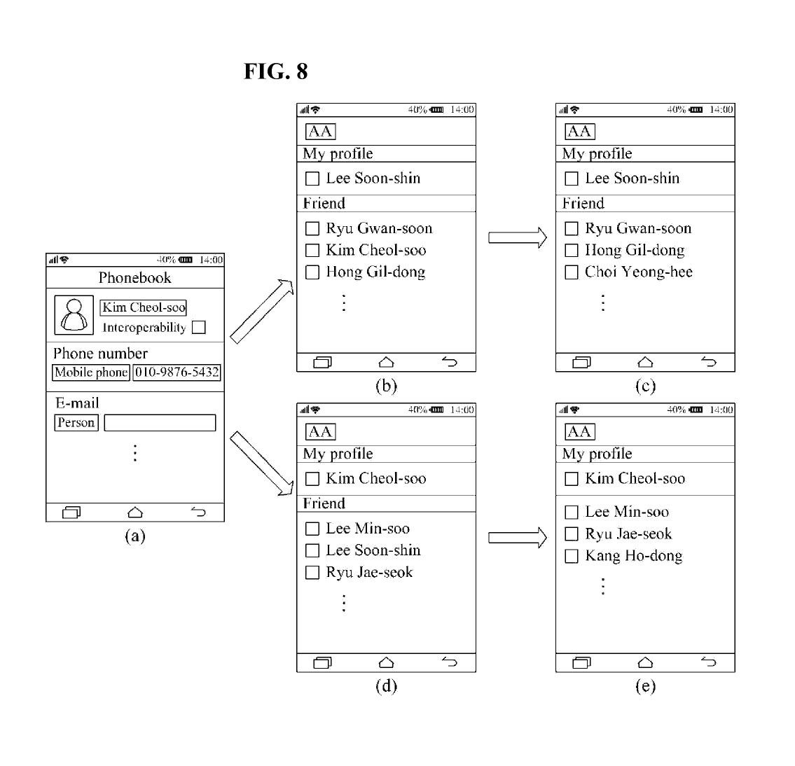

FIG. 8 is a diagram illustrating a program referring to a phonebook interoperability filter, a user interface, and a phonebook database according to an exemplary embodiment of the present invention.

Referring to FIG. 8, a display of a phonebook program may display a user interface feature, for example, an interoperability checkbox as shown in (a) of FIG. 8. When a user inputs a mark on the interoperability checkbox of the user interface, the user may set to permit interoperability of information associated with a phonebook object Kim Cheol-soo with an access requesting program. When a user does not input the mark on the interoperability checkbox of the user interface, the user may set to disallow interoperability of information associated with the phonebook object Kim Cheol-soo with the access requesting program.

Referring to (b) of FIG. 8, when a user, Lee Soon-shin, inputs a mark on a checkbox displayed next to the user's name on a user interface, a display of phonebook objects that may be available for selection for interoperating with the user, Lee Soon-shin, is displayed for program AA, which may refer to a phonebook database. In an example, the phonebook objects may be provided from the phonebook program belonging to the user, Lee Soon-shin. More specifically, phonebook objects that may be selected to interoperate with the user in program AA includes Kim Cheol-soo as shown in (b) of FIG. 8. The listing of Kim Cheol-soo with respect to Lee Soon-shin may indicate that information associated with Kim Cheol-soo is included in the phonebook database of the phonebook program installed on a device of the user, Lee Soon-shin.

Also, as the user marks the user interface, the access requesting program may transmit a request for registering of the phonebook object Kim Cheol-soo as a contact for the access requesting program AA to a server. In response to the request, the server may register information associated with the user, Lee Soon-shin, in a contact list of Kim Cheol-soo, which may be included in a server database, and may transmit the request received from the user to an access requesting program installed on a device of Kim Cheol-soo. Further, the access requesting program of Kim Cheol-soo may add information associated with the user, Lee Soon-shin, to the phonebook database of the access requesting program of Kim Cheol-soo.

Further, when the user unmarks the checkbox next to Kim Cheol-soo, displayed on the user interface, Kim Cheol-soo may be removed from the display available phonebook objects for the access requesting program AA as shown in (c) of FIG. 8. Accordingly, information associated with the phonebook object Kim Cheol-soo may be deleted from the phonebook database of the access requesting program.

Also, as the user unmarks the checkbox next to Kim Cheol-soo on the user interface, the access requesting program of the user may transmit a request for removing from Kim Cheol-soo from a list of contacts of Lee Soon-shin to the server. Also, the server may delete information associated with the user, Lee Soon-shin, from the contact list of Kim Cheol-soo, which may be included in the server database. Further, the access requesting program of Kim Cheol-soo may transmit the request for removal of Kim Cheol-soo from the contact list of the user, which is received from the user, to the access requesting program of Kim Cheol-soo. Accordingly, dissimilar to the display of the access requesting program of Kim Cheol-soo as shown in (d) of FIG. 8, the user, Lee Soon-shin, may be removed from the display of the access requesting program of Kim Cheol-soo as shown in (e) of FIG. 8, and information associated with the user, Lee Soon-shin, may be deleted from the phonebook database of the access requesting program of Kim Cheol-soo.

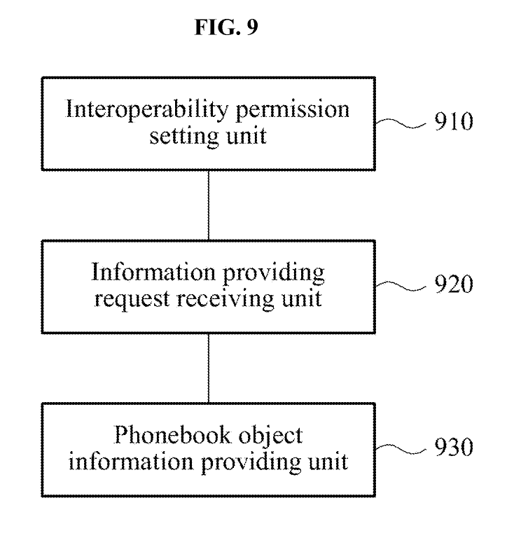

FIG. 9 is a diagram illustrating a configuration of the devices of FIG. 1A, FIG. 1B, and FIG. 1C according to an exemplary embodiment of the present invention.

Referring to FIG. 9, an interoperability permission setting unit 910 may set or permit whether a phonebook object included in a phonebook database may interoperate with a program referring to a phonebook database or an access requesting program. Also, although not illustrated, the interoperability permission setting unit 910 may include a selection input unit and a phonebook interoperability field configuring unit. The selection input unit may receive, from a user, an input of a selection as to whether the interoperability is permitted. Also, the phonebook interoperability field configuring unit may configure a phonebook interoperability field based on the selection as to whether the interoperability is permitted. Also, the interoperability permission setting unit 910 may be configured to be included in, for example, a phonebook program 120 of FIG. 1A. Further, a portion of the units may be configured to be included in another element or component of the device.

Also, an information providing request receiving unit 920 may receive an information request for a phonebook object from an access requesting program. The information providing request receiving unit 920 may be configured to be included in, for example, the phonebook program 120 of FIG. 1A. Further, a portion of the units may be configured to be included in another element or component of the device.

Also, a phonebook object information providing unit 930 may provide information of a phonebook object to an access requesting program for a phonebook object permitted to interoperate with the access requesting program among phonebook objects. Also, although not illustrated, the phonebook object information providing unit 930 may include an interoperability permission determining unit, a phonebook object information extracting unit, and an extracted information providing unit. The interoperability permission determining unit may determine whether the phonebook object may interoperate with the access requesting program by referring to a phonebook interoperability field. Also, when the phonebook object is set or permitted to interoperate with the access requesting program, the phonebook object information extracting unit may extract information of the phonebook object to be provided to the access requesting program. Further, the extracted information providing unit may provide the extracted information of the phonebook object to the access requesting program. The phonebook object information providing unit 930 may provide information requested from the access requesting program among information of the phonebook object permitted to interoperate with the access requesting program.

For example, when the information of the phonebook object includes, as contact information, at least one of mobile phone information, wired phone information, and electronic mail information, and when a first program is a program requesting mobile phone information, more specifically, a program set or permitted to interoperate with a mobile phone number, the phonebook object information providing unit 930 may only provide mobile phone information. Similarly, when a second program is a program requesting electronic mail information, more specifically, a program set or permitted to interoperate with electronic mail information, the phonebook object information providing unit 930 may only provide electronic mail information. The phonebook object information providing unit 930 may be configured to be included in the interoperability filter 140 of FIG. 1A and interoperability filter 160 of FIG. 1B. Further, the phonebook object information providing unit 930 may be configured to be included in the phonebook program 120, the interoperability filter 140 and/or the interoperability filter 160 by each portion of function units. Also, a portion of functions units of the phonebook object information providing unit 930 may be configured to be included in other element or component than the phonebook program 120, the interoperability filter 140, and/or the interoperability filter 160.

The disclosure provided through FIGS. 1 through 8 may be applied to the device of FIG. 9, and a further detailed description is omitted herein.

Aspects of the invention may be recorded in computer-readable media including program instructions to implement various operations embodied by a computer. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard discs, floppy discs, and magnetic tape; optical media, such as compact disc read-only memory (CD ROM) discs and digital versatile disc (DVD); magneto-optical media, such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for controlling synchronization in a first device, the method comprising:
receiving, from a first access requesting program, a request for accessing a phonebook object stored in the first device;
determining whether the phonebook object is permitted to interoperate with the first access requesting program; and
providing information of the phonebook object if the phonebook object is determined to be permitted to interoperate with the first access requesting program.

2. The method of claim 1, wherein information of the phonebook object comprises at least one of contact information and identification information.

3. The method of claim 2, wherein the contact information comprises at least one of mobile phone information, wired phone information, electronic mail information, and address information.

4. The method of claim 2, wherein the identification information comprises at least one of name information, nickname information, avatar information, and picture information.

5. The method of claim 1, further comprising:
blocking access to the information of the phonebook object for the first access requesting program if the phonebook object is determined to not be permitted to interoperate with the first access requesting program.

6. The method of claim 1, further comprising:
setting interoperability permission for the phonebook object for the first access requesting program.

7. The method of claim 1, further comprising:
if the phonebook object is determined to not be permitted to interoperate with the first access requesting program, requesting the first access requesting program to remove contact information corresponding to the phonebook object from a contact list of the first access requesting program.

8. The method of claim 1, further comprising:
if the phonebook object is determined to not be permitted to interoperate with the first access requesting program, transmitting, to a server, a request for removing contact information corresponding to the phonebook object from a contact list of the first access requesting program, wherein the contact list of the first access requesting program is stored on the server.

9. The method of claim 1, further comprising:
if the phonebook object is determined to not be permitted to interoperate with the first access requesting program, transmitting, to a server, a request for removing, from a contact list of a second access requesting program of a user of a second device, contact information corresponding to a user of the first device,
wherein the contact list of the second access requesting program is stored on the server.

10. A method for controlling synchronization in a server, the method comprising:
receiving, from a first user, a request for removing contact information of the first user from a contact list of the second user stored in the server;
removing contact information of the first user from the contact list of the second user; and
transmitting, to an access requesting program of the second user, the request for removing contact information of the first user from a contact list of the access requesting program of the second user,
wherein the access requesting program of the second user is installed in a device of the second user.

11. A first device to control synchronization of contact information, the first device comprising:
a storage to store a phonebook object and to receive, from a first access requesting program, a request to access information of the phonebook object;
an interoperability filter to set an interoperability permission of the phonebook object with respect to the first access requesting program; and
an interoperability management unit to determine whether the first access requesting program is permitted to interoperate with the phonebook object according to the interoperability permission, to store the interoperability permission of the first access requesting program, and to allow providing of information of the phonebook object if the phonebook object is determined to be permitted to interoperate with the first access requesting program.

12. The first device of claim 11, wherein, if the phonebook object is determined to not be permitted to interoperate with the first access requesting program, the interoperability management unit blocks the first access requesting program from accessing the information of the phonebook object.

13. The first device of claim 11, wherein, if the phonebook object is determined to not be permitted to interoperate with the first access requesting program, the first access requesting program removes contact information corresponding to the phonebook object from a contact list of the first access requesting program.

14. The first device of claim 11, wherein, if the phonebook object is determined to not be permitted to interoperate with the first access requesting program, the first device transmits, to a server, a request to remove contact information corresponding to the phonebook object from a contact list of the first access requesting program,
wherein the contact list of the first access requesting program is stored on the server.

15. The first device of claim 11, wherein, if the phonebook object is determined to not be permitted to interoperate with the first access requesting program, the first device transmits, to a server, a request to remove, from a contact list of a second access requesting program of a user of a second device, contact information corresponding to a user of the first device,
wherein the contact list of the second access requesting program is stored on the server.

16. The first device of claim 11, wherein the interoperability filter sets interoperability permission based on an input selection received through a user interface.
